(19) United States
(12) Patent Application Publication
(10) Pub. No.: US 2005/0228912 A1
(43) Pub. Date: Oct. 13, 2005

(54) Memory address bus termination control

(76) Inventors: Clinton F. Walker, Portland, OR (US); James A. McCall, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/814,074

(22) Filed: Mar. 30, 2004

(51) Int. Cl. G06F 13/00

(52) U.S. Cl. 710/107

(57) ABSTRACT

A memory device includes address bus termination circuitry that can be enabled or disabled depending on the state of an address bus termination control signal. A memory module may be made up of several of these memory devices with each memory device including address bus termination circuitry. The memory devices may be coupled to an address bus in a daisy chain configuration. In the case of a daisy chain configuration it may be desirable to only enable the address bus termination circuitry of the last memory device in the chain. The address bus termination circuitry of the last memory device in the chain can be enabled by tying its address bus termination control signal to a positive voltage. The address bus termination control signals of the other memory devices can be tied to ground in order to disable their address bus termination circuitry.

### FIELD OF THE INVENTION

The present invention pertains to the field of computer systems. More particularly, this invention pertains to the field of providing termination for memory address busses.

### BACKGROUND OF THE INVENTION

In an effort to increase overall computer system performance, system designers seek to improve memory subsystem performance. One method of increasing memory subsystem performance includes speeding up the operation of address busses between memory controllers and memory modules. Memory modules typically include several individual memory devices that are coupled to an address bus in a daisy chain configuration. The speed of operation of address busses on memory modules is increasing to the point where signal integrity issues are becoming important.

Prior computer systems have had to deal with signal integrity issues involving data busses on memory modules by providing termination circuitry on the memory module or in the individual memory devices, but similar efforts have not been needed in the past for address busses.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 is a block diagram of a memory device including address bus termination circuitry and an address bus termination control signal input.

FIG. 2 is a block diagram of a memory module including several memory devices.

### DETAILED DESCRIPTION

In general, a memory device includes address bus termination circuitry that can be enabled or disabled depending on the state of an address bus termination control signal. A memory module may be made up of several of these memory devices with each memory device including address bus termination circuitry. The memory devices may be coupled to an address bus in a daisy chain configuration. In the case of a daisy chain configuration it may be desirable to only enable the address bus termination circuitry of the last memory device in the chain. The address bus termination circuitry of the last memory device in the chain can be enabled by tying its address bus termination control signal to a positive voltage. The address bus termination control signals of the other memory devices can be tied to ground in order to disable their address bus termination circuitry.

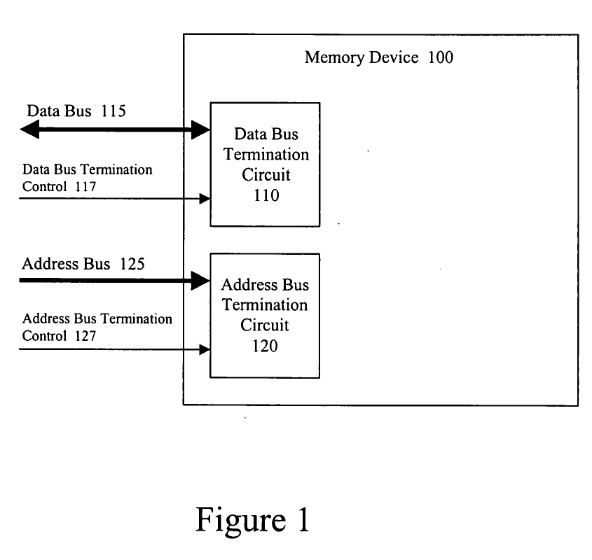

FIG. 1 is a block diagram of a memory device 100. The memory device 100 is coupled to a data bus 115 and an address bus 125. The memory device 100 further includes a data bus termination circuit 110 and an address bus termination circuit 120. The data bus termination circuit 110 is controlled by a data bus termination control signal 117 and the address bus termination circuit 120 is controlled by an address bus termination control signal 127. If the termination control signal 127 is asserted, then the address bus termination circuit 120 becomes enabled. If the termination control signal 127 is not asserted, then the address bus termination circuit 120 is disabled. Similarly, if the data bus termination control signal 117 is asserted, then the data bus termination circuit 110 is enabled. If the data bus termination control signal 117 is not asserted, then the data bus termination circuit 110 is disabled.

The memory device 100 may be any of a wide range of types of memory devices, including, but not limited to, double data rate (DDR) memory devices. Further, although memory device 100 includes termination circuitry for a data bus, other embodiments are possible where there is no termination circuitry for the data bus in the memory device.

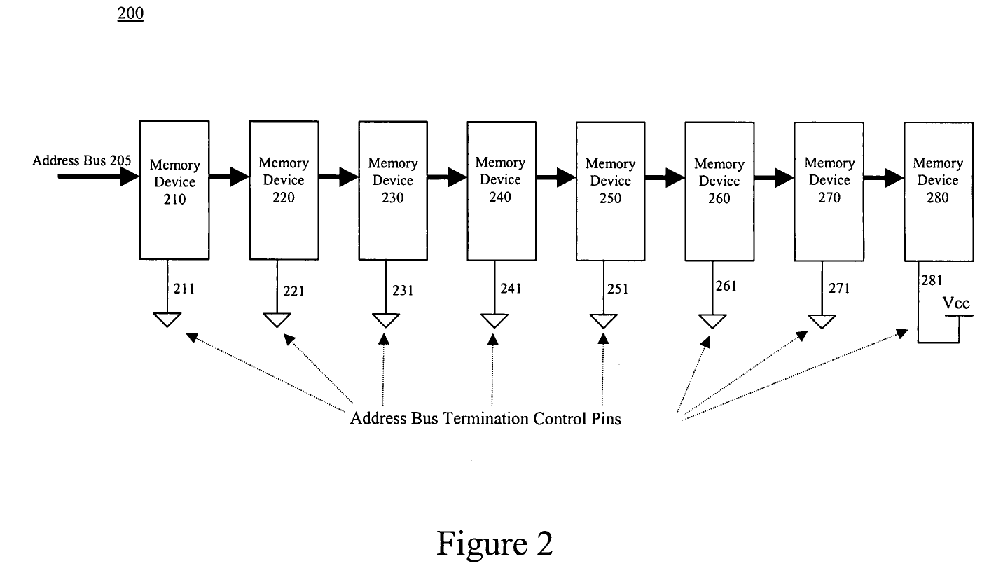

FIG. 2 is a block diagram of one embodiment of a memory module 200 including several memory devices 210, 220, . . . 280. Each of the memory devices 210, 220, . . . 280 may be a device such as that discussed above in connection with FIG. 1. Each of the devices 210, 220, . . . 280 includes address bus termination circuitry (not shown, but see FIG. 1) and address bus termination control signal pins 211, 221, . . . 281, respectfully. The memory devices 210, 220, . . . 280 are coupled to an address bus 205 in a daisy chain configuration.

For the current example embodiment using a daisy chain configuration, it may be desirable to enable the address bus termination circuitry for only the last memory device in the chain, which in this case is device 280. The address bus termination control signal input 281 is tied to a positive voltage which enables the termination circuitry. The address bus termination control signal pins 211, 221, . . . 271 for the remainder of the memory devices are coupled to ground in order to disable the address bus termination circuits in memory devices 210, 220, . . . 270.

The term “pin” as used herein is meant to denote any means of providing electrical, magnetic, or optical connection between a memory device and a memory module, including, but not limited to, pins, leads, or balls. Further, although for the current example the termination circuitry is enabled when the address bus termination control pins are tied to a positive voltage, other embodiments are possible where the termination circuitry is enabled when the address bus termination control pins are coupled to ground. Yet other embodiments may use other voltage or signaling schemes to enable and disable the address bus termination circuitry.

For the current example embodiment, the address bus termination circuitry of the individual memory devices are enabled or disabled depending on how the address bus termination control pins are coupled to the memory module. Other embodiments are possible where the address bus termination control signals are delivered by a memory controller or some other device.

The example memory module 200 is only one of a wide range of possible memory module configurations. Also, other embodiments are possible where the memory devices such as that discussed above in connection with FIG. 1 are located elsewhere other than on a memory module.

In the foregoing specification the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than in a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

1. A memory device, comprising:
an address bus interface;
an address bus termination circuit that can be enabled or disabled; and
an address bus termination control signal input.

2. The memory device of claim 1, the address bus termination circuit to be enabled if an asserted address bus termination control signal is received at the address bus termination control signal input.

3. The memory device of claim 2, the address bus termination circuit to be disabled if the address bus termination control signal is not asserted.

4. The memory device of claim 3, wherein the address bus termination control signal is asserted when at a logically high voltage level and is not asserted when at a logically low voltage level.

5. The memory device of claim 3, wherein the address bus termination control signal is asserted when at a logically low voltage level and is not asserted when at a logically high voltage level.

6. The memory device of claim 3, further comprising a data bus interface and a data bus termination circuit.

7. The memory device of claim 6, further comprising a data bus termination control signal input, the data bus termination circuit to be enabled in response to an asserted data bus termination control signal.

8. A memory module, comprising:
a plurality of memory devices coupled to an address bus in a daisy chain configuration, each of the plurality of memory devices including
an address bus interface,
an address bus termination circuit that can be enabled or disabled, and
an address bus termination control signal input.

9. The memory module of claim 8, wherein for each of the plurality of memory devices the address bus termination circuit is enabled if an asserted address bus termination control signal is received at the address bus termination control signal input.

10. The memory module of claim 9, wherein for each of the plurality of memory devices the address bus termination circuit is disabled if the address bus termination control signal is not asserted.

11. The memory module of claim 10, wherein for each of the plurality of memory devices the address bus termination control signal is asserted when at a logically high voltage level and is not asserted when at a logically low voltage level.

12. The memory module of claim 11, wherein all but the last memory device in the daisy chain configuration has its address bus termination control signal input tied to ground and the last memory device in the daisy chain configuration has its address bus termination control signal tied to a positive voltage.

13. The memory module of claim 10, wherein for each of the plurality of memory devices the address bus termination control signal is asserted when at a logically low voltage level and is not asserted when at a logically high voltage level.

14. The memory module of claim 13, wherein all but the last memory device in the daisy chain configuration has its address bus termination control signal input tied to a positive voltage and the last memory device in the daisy chain configuration has its address bus termination control signal tied to ground.

15. The memory module of claim 10, wherein each of the plurality of memory devices further includes a data bus interface and a data bus termination circuit.

16. The memory module of claim 15, wherein each of the plurality of memory devices further includes a data bus termination control signal input, the data bus termination circuit to be enabled in response to an asserted data bus termination control signal.

17. A method, comprising:
connecting in a daisy chain configuration an address bus to a plurality of memory devices on a memory module;
providing address bus termination circuitry in the plurality of memory devices; and
enabling the address bus termination circuitry of only one of the plurality of memory devices.

18. The method of claim 17, wherein enabling the address bus termination circuitry of only one of the plurality of memory devices includes enabling the address bus termination circuitry of the last memory device in the daisy chain configuration.

19. The method of claim 18, wherein enabling the last memory device in the daisy chain configuration includes coupling an address bus termination control pin to a positive voltage.

20. The method of claim 19, wherein enabling the address bus termination circuitry of only one of the plurality of memory devices includes disabling the address bus termination circuits in all but the last memory device in the daisy chain configuration by coupling address bus termination control pins on all but the last memory device to ground.
